(19) United States
(12) Patent Application Publication
(10) Pub. No.: US 2008/0242306 A1
(43) Pub. Date: Oct. 2, 2008

(54) Apparatus and Method to Facilitate Use of a Cookie to Protect an Intranet

(75) Inventors: Sean C. Fletcher, Lake in the Hills, IL (US); Matthew S. Beveridge, St. Charles, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/691,900

(22) Filed: Mar. 27, 2007

(51) Int. Cl. H04Q 7/20

(52) U.S. Cl. 455/445

(57) ABSTRACT

A wireless two-way communications device (206) can provide to a network gateway (200) for a particular protected intranet a cookie that comprises, at least in part, a substantially unique identifier for the wireless two-way communications device and a temporal stamp as corresponds to the assignment of that substantially unique identifier. The network gateway can then arrange for the processing (105) of this cookie to recover the substantially unique identifier and the temporal stamp and the automatic use (106) of that recovered information to determine whether to provide the wireless two-way communications device with access to information contained within the protected intranet. By one approach, such a cookie can be provided in conjunction with additional information such as a personal identification number, device agent information, and/or carrier information.

### TECHNICAL FIELD

This invention relates generally to network gateways and more particularly to network gateways that operably couple intranets to external networks.

### BACKGROUND

Communication networks of various kinds are known in the art. Generally speaking, these include both intranets and extranets. An intranet typically comprises an internal use, private network inside an enterprise and often comprises one that uses the Transfer Control Protocol/Internet Protocol standards. An intranet therefore comprises a private site that is typically only accessible to enterprise employees or other specifically authorized entities (such as contractors, suppliers, and the like). As used herein, an extranet will be understood to refer to a public network that also makes use of the Transfer Control Protocol/Internet Protocol standards (with the Internet comprising an extremely well known example of such a public network) and hence is typically accessible, at least in some measure, by the general public.

In certain instances, the administrator of an intranet may wish to provide full or limited access to information contained therein to selected entities that are external to the intranet. This can occur, for example, when employees of the corresponding enterprise are traveling and are not physically within the protected confines of the enterprise itself. To meet such a need it is well known in the art to permit such an external entity to gain access to a given intranet via a corresponding wireless two-way communications device and an extranet such as the Internet. Providing such access, however, can raise serious questions and concerns regarding the informational integrity and security of the intranet itself.

Accordingly, various mechanisms and schemes have been proposed that attempt, one way or the other, to preserve the relative security of the intranet as achieved through isolation while nevertheless permitting access to that intranet via an extranet. While suitable for at least some application settings, such proposals to date nevertheless often leave much to be desired. Access procedures can be burdensome, confusing, and unduly dependent upon the knowledge and training of the end user. Access latency can comprise a further area of objection and user dissatisfaction.

### BRIEF DESCRIPTION OF THE DRAWINGS

The above needs are at least partially met through provision of the apparatus and method to facilitate use of a cookie to protect an intranet described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a wireless two-way communications device can provide to a network gateway for a particular protected intranet a cookie that comprises, at least in part, a substantially unique identifier for the wireless two-way communications device and a temporal stamp as corresponds to the assignment of that substantially unique identifier. The network gateway can then arrange for the processing of this cookie to recover the substantially unique identifier and the temporal stamp and the automatic use of that recovered information to determine whether to provide the wireless two-way communications device with access to information contained within the protected intranet.

By one approach, the substantially unique identifier and the temporal stamp can be combined with one another. Further, in combination with or in lieu of the above, all or part of this information can be encrypted to provide security during transmission of such content to the network gateway. Depending upon the needs and/or opportunities presented in a given application setting, this cookie can be combined with other useful content such as, but not limited to, a Personal Identification Number for a user of the wireless two-way communications device, information regarding a corresponding device/browser agent, and/or information regarding a carrier network as corresponds to the wireless two-way communications device, to note but a few examples in this regard.

Those skilled in the art will recognize and appreciate that such teachings provide a ready and efficient mechanism well capable of serving as a satisfactory basis for authenticating a given wireless two-way communications device and/or user with respect to permitting access to information contained within a protected intranet. These teachings are readily facilitated through the appropriate leveraging of existing capabilities such as cookie provisioning, maintenance, and exchanges. It will be readily understood that these teachings are also readily scalable and can accommodate both a wide population base of corresponding users as well as a myriad of differing application settings.

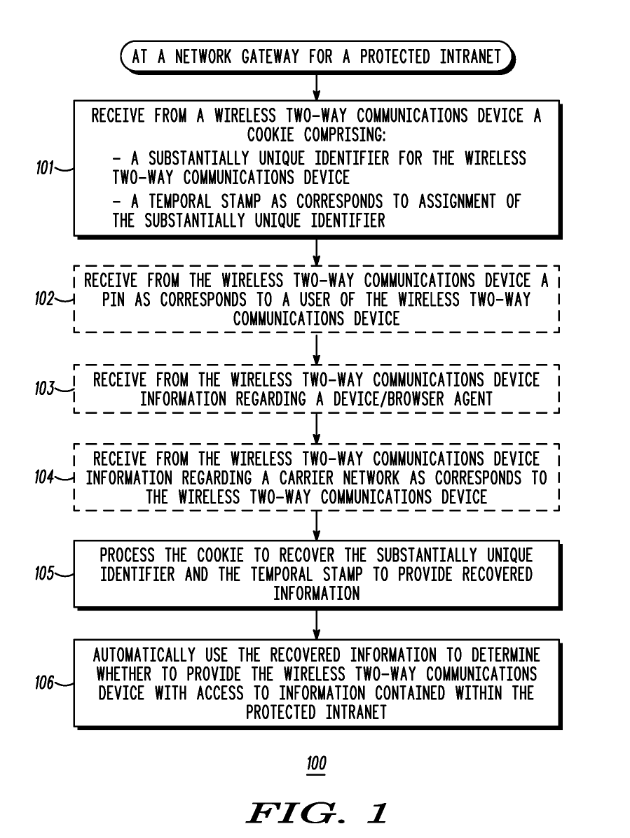

These and other benefits may become clearer upon making a thorough review and study of the following detailed description. Referring now to the drawings, and in particular to FIG. 1, an illustrative process 100 suitable to represent at least certain of these teachings will be described. In this example, a network gateway facilitates the illustrated process 100. Various such platforms are known in the art. Those skilled in the art will understand that such an entity can comprise a physically integral platform or can comprise a virtual platform having various elements of its functionality dispersed over a plurality of participating platforms. Such architectural options are well understood in the art and require no further elaboration here.

Also in this illustrative example, the network gateway serves, at least in part, to protect at least one corresponding intranet from unauthorized access. As will be described below in more detail, this network gateway can be configured and arranged to serve as a gateway between this protected intranet and one or more extranets (such as, but not limited to, the Internet). As noted above, such an extranet will typically comprise a wholly or at least partially unprotected network with access being largely publicly available.

Pursuant to this process 100 the network gateway receives 101, from a wireless two-way communications device, a cookie. As will be well-understood by those skilled in the art, cookies are parcels of text that are typically sent by a server to a client-side web browser. This cookie can then be returned, typically unchanged, by the browser each time it accesses that server. Such cookies are typically used for authenticating, tracking, and maintaining specific information about users, such as site preferences or the like.

Pursuant to one approach as per these teachings, this cookie as received from the wireless two-way communications device comprises, at least in part, a substantially unique identifier for the wireless two-way communications device as well as a temporal stamp that corresponds to the assignment of the substantially unique identifier. If desired, this received cookie can be encrypted, in whole or in part (as a function, for example, of a one-way hash or encryption approach as is known in the art). Also if desired, these two items of content within the cookie can comprise discrete, physically separated items of information or can be combined. If combined, any of a wide variety of approaches can serve. For example, these items of information can be concatenated one to the other. As another example, the bits that comprise each item of information can be interleaved with one another using any of a wide variety of practices in this regard. Other approaches to making such a combination will no doubt occur to those skilled in the art.

The substantially unique identifier can be based, initially, upon any of a wide variety of sources. By one approach, the wireless two-way communications device itself can suggest, in whole or in part, the identifier and/or a seed value that can serve to facilitate derivation of the identifier. By another approach, the network gateway or some other trusted source can select, derive, or otherwise provide such an identifier to be used by the wireless two-way communications device. Pursuant to these teachings, this substantially unique identifier will correspond and correlate to the wireless two-way communications device itself. If desired, however, and as discussed below, these teachings will also accommodate use of a unique identifier for a user of that wireless two-way communications device.

As noted above, the temporal stamp corresponds to the assignment of that substantially unique identifier. By one approach, this temporal stamp can comprise, or at least reflect, a time at which the substantially unique identifier was first assigned to the wireless two-way communications device (where “time” will be understood to refer to one or more of a year, a month, a day, an hour, a minute, or some other subdivision of time as may presently exist or be hereafter defined). By another approach, this temporal stamp can comprise, or at least reflect, a time at which the substantially unique identifier first becomes effective (even if received or otherwise provided to the wireless two-way communications device at an earlier time). By yet another example, this temporal stamp can comprise, or at least reflect, a duration of time during which the substantially unique identifier is effective and/or an expiration time at which the substantially unique identifier ceases, at least in part, to be effective.

For the sake of illustration and not by way of limitation, consider a more specific example in this regard. A given unique identifier for a given user platform might be “123456” and it may have been provisioned on Jun. 22, 2006 at 3:43:57 PM. That time could be represented as, for example, “20060622154357.” Through a simple concatenation, these two pieces of data could be combined to yield “12345620060622154357.” As noted, this could then be encrypted (to yield something like, for example, “mNBK6xkmz213hD4+ATkVkQ==”). The latter could then comprise the aforementioned cookie for this particular user platform.

Those skilled in the art will recognize that the above examples can be combined in various ways with one another and further that the examples provided are intended to serve only in an illustrative capacity. Generally speaking, these teachings anticipate that such a temporal stamp will be sourced in the first instance by the network gateway itself though alternatives are possible and may even be preferable in certain operational settings.

As alluded to above, this process 100 will also accommodate optionally receiving 102, from the wireless two-way communications device, a Personal Identification Number (PIN) as corresponds to a user of the wireless two-way communications device. This PIN can comprise a part of a message that also includes the aforementioned cookie or can comprise a separate item of information. When sharing a same message as the cookie, this PIN information can comprise, for example, a part of the hypertext transfer protocol (HTTP) header that also bears the cookie. PIN's themselves are well known in the art. As the present teachings are not overly sensitive to the selection of any particular approach in this regard, for the sake of brevity and the preservation of clarity additional elaboration in this regard will not be provided here.

This process 100 can also optionally accommodate receiving 103, again from the wireless two-way communications device, information regarding a given device/browser agent. Those skilled in the art will understand and recognize that an agent string traditionally identifies what type and version of web browser is presently accessing a web site. This information is transmitted in the HTTP headers as part of the browser's initial communication with a website. In the world of mobile devices, manufacturers such as Motorola have incorporated some device specific information into the agent string such as a given device's commercial name (“MOT-V3,” for example, is a portion of the RAZR cellular telephone's agent string). Again, such agents and such characterizing information is generally known in the art and requires no further description here.

This process 100 can also further optionally accommodate receiving 104, again from the wireless two-way communications device, information regarding a carrier network as corresponds to the wireless two-way communications device. Carrier network information is often specifically conveyed via a two-way communications device's Internet Protocol (IP) address. This IP address (as is well known to those skilled in the art) is assigned by the device's carrier when the device is powered on. Because the address must typically come from a pool of available addresses (such as network or sub-network addresses) that is dedicated and assigned to said carrier, the IP address can be cross-referenced to a table of assigned network ranges to determine which carrier that device is using to gain access to the Internet. Once again, carrier networks and their characterizing information comprises a well-understand area of endeavor and requires no further elaboration here.

In any event, this process 100 then provides for processing 105 this cookie to recover the substantially unique identifier and the temporal stamp to provide corresponding recovered information. By one approach, when part or all of this information comprises encrypted information, this step can include decrypting the encrypted information to reveal the unencrypted content. By another approach, and particularly when the relevant information in the cookie comprises content that has been encrypted using a one-way hash, the information can be used as a unique identifier to access a look-up table to thereby provide the above-mentioned recovered information.

However gained, this recovered information is then automatically used 106 to determine whether to provide the wireless two-way communications device with access to information contained within the protected intranet. By one approach, this can comprise confirming both the identity of the wireless two-way communications device as well as a present authorized status of that identity as correlates, at least in part, to the corresponding temporal stamp.

So configured, of course, it will be insufficient to simply know the identity by which a given protected intranet identifies a given wireless two-way communications device. An authorized party must also have evidence of a corresponding present authority (in the form of the temporal stamp) which evidence must match that held by the network gateway.

As noted above, these teachings will accommodate also providing a user's PIN, information regarding a corresponding device/browser agent, and/or information regarding a carrier network as corresponds to the wireless two-way communications device. When arranging and planning for the provision of such additional content, the aforementioned step of using the recovered information to determine whether to provide the described access can further comprise using such additional content as a way of further validating the attendant basis of this right to access the protected intranet.

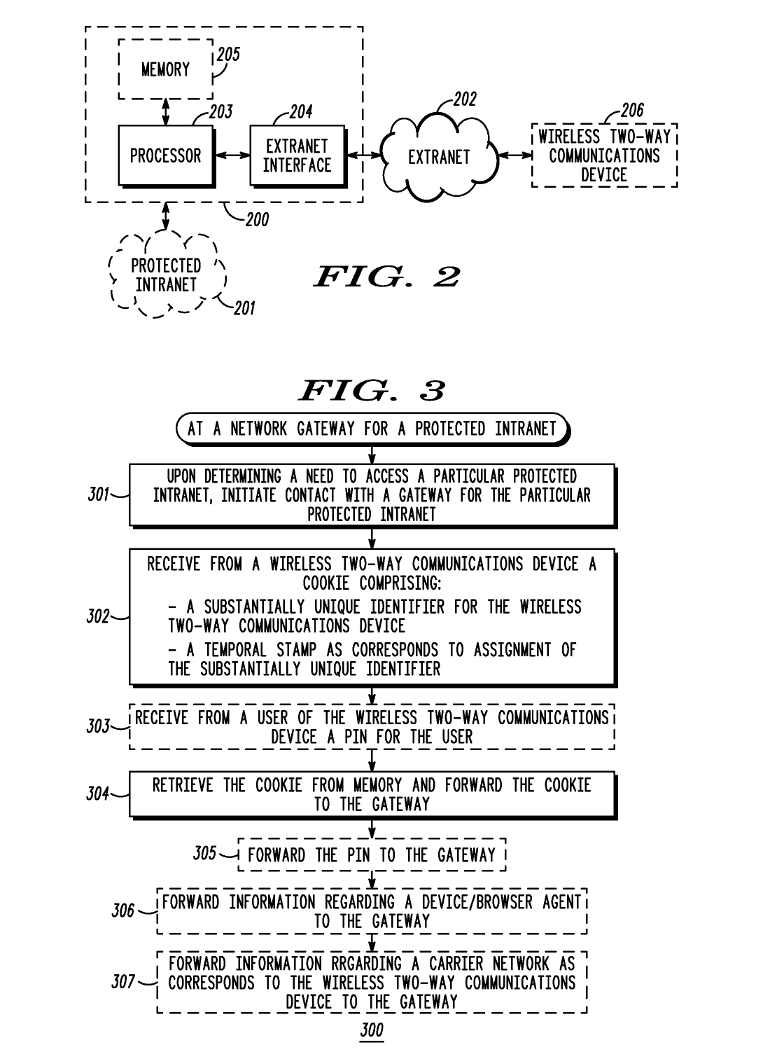

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment, a network gateway 200 serves as a gateway and point of control between a protected intranet 201 of choice and an extranet 202 of choice (such as, but not limited to, the Internet). Here, the network gateway 200 comprises a processor 203 that operably couples to an extranet interface 204. The latter operably couples to the extranet 202 and is configured and arranged to receive the aforementioned cookie (and other supplemental information when in use). By one approach, of course, this can comprise configuring the extranet interface 204 to facilitate requesting such a cookie from the wireless two-way communications device 206 when the latter seeks to access the protected intranet 201.

The processor 203, in turn, can be configured and arranged (via, for example, programming) to carry out any or all of the steps as are set forth herein. This can include, of course, the steps of processing received cookies and using recovered cookie content to automatically determine whether to provide a given wireless two-way communications device 206 with the sought-for access to the protected intranet 201. By one approach, the network gateway 200 can further comprise a memory 205 that operably couples to the processor 203 and that serves to store, for example, the aforementioned look-up table. Other possibilities in such regards are possible as well, of course.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

To facilitate such functionality and activities, and referring now to FIG. 3, these teachings will also provide for a corresponding process 300 to be implemented via a wireless two-way communications device. Pursuant to this process 300, upon determining 301 a need to access a particular protected intranet, initiating contact with a network gateway for that particular protected intranet. This can comprise contacting the network gateway as described above in an appropriate instance.

This process 300 will then support receiving 302 from that gateway a request for a cookie wherein the cookie comprises the substantially unique identifier and the temporal stamp content as described herein. This process 300 can also optionally include receiving 303 from a user of the wireless two-way communications device a PIN for that user to support the purposes described above.

In any event, the wireless two-way communications device can then retrieve 304 the cookie from, for example, memory and forward that cookie to the network gateway. This, of course, serves to provide the network gateway with the cookie to thereby facilitate carrying out the acts and steps described above. This process 300 will also optionally provide for forwarding 305 the user's PIN, forwarding 306 information regarding a device/browser agent as corresponds to the wireless two-way communications device, and/or forwarding 307 information regarding a carrier network as corresponds to the wireless two-way communications device to the network gateway when such content also comprises a compulsory (or at least optional) offering and showing.

So configured, these teachings provide a simple, yet effective and relatively secure mechanism for ensuring the present authorized status of a given wireless two-way communications device prior to supplying such an entity with access to and information from a protected intranet. By successfully leveraging the relatively ubiquitous cookie exchange capability that numerous extranet and intranet-capable platforms already presently possess, these teachings can be readily implemented in a cost effective manner. Those skilled in the art will recognize and appreciate that this can include a sizeable population of legacy platforms.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network gateway for a protected intranet:
receiving from a wireless two-way communications device a cookie comprising, at least in part:
a substantially unique identifier for the wireless two-way communications device;
a temporal stamp as corresponds to assignment of the substantially unique identifier;
processing the cookie to recover the substantially unique identifier and the temporal stamp to provide recovered information;
automatically using the recovered information to determine whether to provide the wireless two-way communications device with access to information contained within the protected intranet.

2. The method of claim 1 wherein the cookie comprises, at least in part, an encrypted cookie.

3. The method of claim 2 wherein the substantially unique identifier and the temporal stamp are combined with one another and comprise an encrypted portion of the encrypted cookie.

4. The method of claim 1 wherein the temporal stamp comprises a point in time when the substantially unique identifier was assigned to the wireless two-way communication device.

5. The method of claim 1 wherein the substantially unique identifier comprises a substantially unique identifier as has been assigned to the wireless two-way communications device from within the protected intranet.

6. The method of claim 1 further comprising:
receiving from the wireless two-way communications device a personal identification number (PIN) as corresponds to a user of the wireless two-way communications device;
and wherein automatically using the recovered information to determine whether to provide the wireless two-way communications device with access to information contained within the protected intranet further comprises automatically using the recovered information and the personal identification number to determine whether to provide the wireless two-way communications device with access to information contained within the protected intranet.

7. The method of claim 6 further comprising:
receiving from the wireless two-way communications device information regarding a device/browser agent;
and wherein automatically using the recovered information and the personal identification number to determine whether to provide the wireless two-way communications device with access to information contained within the protected intranet further comprises automatically using the recovered information, the personal identification number, and the information regarding the device/browser agent to determine whether to provide the wireless two-way communications device with access to information contained within the protected intranet.

8. The method of claim 7 further comprising:
receiving from the wireless two-way communications device information regarding a carrier network as corresponds to the wireless two-way communications device;
and wherein automatically using the recovered information, the personal identification number, and the information regarding the device/browser agent to determine whether to provide the wireless two-way communications device with access to information contained within the protected intranet further comprises automatically using the recovered information, the personal identification number, the information regarding the device/browser agent, and the information regarding the carrier network to determine whether to provide the wireless two-way communications device with access to information contained within the protected intranet.

9. A network gateway for a protected intranet comprising:
an extranet interface configured and arranged to receive from a wireless two-way communications device a cookie comprising, at least in part:
a substantially unique identifier for the wireless two-way communications device;
a temporal stamp as corresponds to assignment of the substantially unique identifier;
a processor operably coupled to the extranet interface and being configured and arranged to:
process the cookie to recover the substantially unique identifier and the temporal stamp to provide recovered information;
automatically use the recovered information to determine whether to provide the wireless two-way communications device with access to information contained within the protected intranet.

10. The network gateway of claim 9 wherein the processor is further configured and arranged to process the cookie by, at least in part, using at least a portion of the cookie as a unique identifier to access a look-up table to provide the recovered information.

11. The network gateway of claim 9 wherein the temporal stamp comprises a point in time when the substantially unique identifier was assigned to the wireless two-way communication device.

12. The network gateway of claim 9 wherein the substantially unique identifier comprises a substantially unique identifier as has been assigned to the wireless two-way communications device from within the protected intranet.

13. The network gateway of claim 9 wherein:
the extranet interface is further configured and arranged to receive from the wireless two-way communications device a personal identification number (PIN) as corresponds to a user of the wireless two-way communications device; and
wherein the processor is further configured and arranged to automatically use the recovered information to determine whether to provide the wireless two-way communications device with access to information contained within the protected intranet by automatically using the recovered information and the personal identification number to determine whether to provide the wireless two-way communications device with access to information contained within the protected intranet.

14. The network gateway of claim 13 wherein:
the extranet interface is further configured and arranged to receive from the wireless two-way communications device information regarding a device/browser agent; and
wherein the processor is further configured and arranged to automatically use the recovered information and the personal identification number to determine whether to provide the wireless two-way communications device with access to information contained within the protected intranet by automatically using the recovered information, the personal identification number, and the information regarding the device/browser agent to determine whether to provide the wireless two-way communications device with access to information contained within the protected intranet.

15. The network gateway of claim 14 wherein:
the extranet interface is further configured and arranged to receive from the wireless two-way communications device information regarding a carrier network as corresponds to the wireless two-way communications device; and
wherein the processor is further configured and arranged to automatically use the recovered information, the personal identification number, and the information regarding the device/browser agent to determine whether to provide the wireless two-way communications device with access to information contained within the protected intranet by automatically using the recovered information, the personal identification number, the information regarding the device/browser agent, and the information regarding the carrier network to determine whether to provide the wireless two-way communications device with access to information contained within the protected intranet.

16. A method comprising:
at a wireless two-way communications device:
upon determining a need to access a particular protected intranet, initiating contact with a gateway for the particular protected intranet;
receiving from the gateway a request for a cookie comprising, at least in part:
a substantially unique identifier for the wireless two-way communications device;
a temporal stamp as corresponds to assignment of the substantially unique identifier;
in order to facilitate authorizing accessing the particular protected intranet by the wireless two-way communications device;
retrieving the cookie from memory and forwarding the cookie to the gateway.

17. The method of claim 16 wherein:
retrieving the cookie from memory comprises retrieving the cookie in an encrypted form from the memory; and
forwarding the cookie to the gateway comprises forwarding the cookie in the encrypted form to the gateway.

18. The method of claim 16 further comprising:
receiving from a user of the wireless two-way communications device a personal identification number (PIN) for the user;
forwarding the personal identification number to the gateway to further facilitate authorizing accessing the particular protected intranet by the wireless two-way communications device.

19. The method of claim 18 further comprising:
forwarding information regarding a device/browser agent to the gateway to further facilitate authorizing accessing the particular protected intranet by the wireless two-way communications device.

20. The method of claim 19 further comprising:
forwarding information regarding a carrier network as corresponds to the wireless two-way communications device to the gateway to further facilitate authorizing accessing the particular protected intranet by the wireless two-way communications device.
